(19) United States
(12) Patent Application Publication
(10) Pub. No.: US 2006/0205451 A1
(43) Pub. Date: Sep. 14, 2006

(54) Slide apparatus, slide module and electronic device utilizing the same

(75) Inventor: Long-Jyh Pan, Taipei County (TW)

Correspondence Address: BIRCH STEWART KOLASCH & BIRCH, PO BOX 747, FALLS CHURCH, VA, 22040-0747, US

(73) Assignee: BENQ CORPORATION

(21) Appl. No.: 11/372,277

(22) Filed: Mar. 10, 2006

(30) Foreign Application Priority Data
Mar. 14, 2005 (TW) 94107666

(51) Int. Cl. H04M 1/00

(52) U.S. Cl. 455/575.4

(57) ABSTRACT

A slide apparatus includes a first member, a second member and a torque-retaining assembly. The second member is movable between a first position and a second position in relation to the first member, and a central position exists between the first position and the second position. The torque-retaining assembly is disposed between the first member and the second member. When the second member moves from the first position to the central position and from the second position to the central position in relation to the first member by an external force, the torque-retaining assembly generates torque, and the torque drives the second member from the central position to the first position or the second position.

### BACKGROUND

The invention relates to a slide apparatus and slide module and electronic device utilizing the same.

In recent years, portable electronic devices, such as digital cameras, cellular phones, and electronic dictionaries have become widely popular.

Frequently, portable electronic devices have an integral cover structure, often in configuration, hinged or sliding. An example of an electronic device, here a sliding cover cellular phone, is shown in FIG. 1A and FIG. 1B. The sliding cover cellular phone in FIG. 1A and FIG. 1B has a body 510 and a sliding cover 520. When the cellular phone is not in use, the sliding cover 520 assumes a closed position as shown in FIG. 1A to cover and protect at least part of the body 510. To use the cellular phone, the sliding cover 520 slides to an open position as shown in FIG. 1B to expose the body 510. When not in use, the sliding cover 520 returns to the closed position as shown in FIG. 1A.

In the above-mentioned electronic device, however, the sliding cover is manually operated, with external force required to move the sliding cover to the open or closed position. Thus, the electronic device is not convenient.

### SUMMARY

Accordingly, an exemplary embodiment of a slide apparatus is provided. The slide apparatus comprises a first member, a second member and a torque-retaining assembly. The second member is movable between a first position and a second position in relation to the first member, with a central position. therebetween. The torque-retaining assembly is disposed between the first member and the second member. When the second member moves from the first position to the central position and from the second position to the central position in relation to the first member by an external force, the torque-retaining assembly generates a torque, driving the second member from the central position to the first position or the second position.

The torque-retaining assembly comprises a first slide module, a second slide module and an elastic element. The first slide module and the second slide module are disposed on the first member. The first slide module comprises a first rotating structure, and the second slide module comprises a second rotating structure. When the second member is between the first position and the central position, the first rotating structure is rotatable and the second rotating structure is not rotatable, and when the second member is between the central position and the second position, the second rotating structure is rotatable and the first rotating structure is not rotatable. The elastic element comprises a first end fixed to the first rotating structure and a second end fixed to the second rotating structure to generate the torque.

Another embodiment of the invention discloses an electronic device. The electronic device comprises a first member, a second member, a first slide module, a first sliding track, a second slide module, a second sliding track, and an elastic element. The first member comprises a first sliding notch and a second sliding notch. The second member is movable between a first position and a second position in relation to the first member, with a central position therebetween. The first slide module and the second slide module are disposed on the first member, each comprising a supporting structure and a gear. The first and second sliding tracks are disposed on the second member and correspond to the first and second sliding notches. The first sliding track comprises a first track section and a second track section, and the second sliding track comprises a third track section and a fourth track section. The first track section comprises a first rack, and the fourth track section comprises a second rack. The elastic element comprises a first end fixed to the first gear and a second end fixed to the second gear. When the second member is between the first position and the central position in relation to the first member, the first gear corresponds to the first track section and engages the first rack, moving the first gear to the first free position, and the second gear corresponds to the third track section and is in the second limited position. When the second member is between the central position and the second position in relation to the first member, the first gear corresponds to the second track section and is in the first limited position, and the second gear corresponds to the fourth track section and engages the second rack, moving the second gear to the second free position.

A further embodiment of the invention discloses a slide module. The slide module comprises a supporting structure and a rotating structure. The supporting structure comprises a limiting portion and an elastic cantilever beam. The rotating structure is disposed at a free end of the elastic cantilever beam and movable between a limited position and a free position by the elastic cantilever beam. The rotating structure is not rotatable when the rotating structure is in the limited position and is rotatable when the rotating structure is in the free position.

In the slide apparatus and electronic device, the first and second members can alternatively be a body and a sliding cover.

Further, in the slide apparatus, the rotating structures can be gears.

A detailed description is given in the following embodiments with reference to the accompanying drawings.

### DESCRIPTION OF THE DRAWINGS

The invention can be more fully understood by reading the subsequent detailed description in conjunction with the examples and references made to the accompanying drawings, wherein:

FIG. 1A is a schematic view of a conventional sliding cover electronic device with the sliding cover closed;

FIG. 1B is a schematic view of a conventional sliding cover electronic device with the sliding cover open;

FIG. 2A is a schematic view of an embodiment of a slide apparatus with the second member disposed in the first position;

FIG. 2B is a schematic view of the slide apparatus in FIG. 2A with the second member in the central position;

FIG. 2C is a schematic view of the slide apparatus in FIG. 2A with the second member in the second position;

FIG. 3 is a disassembled view of an embodiment of a sliding cover electronic device;

FIG. 4A is a perspective disassembled view of the first slide module;

FIG. 4B is another perspective disassembled view of the first slide module;

FIG. 4C is a schematic view of the first slide module with the first gear in the first limited position;

FIG. 4D is a schematic view of the first slide module with the first gear in the first free position;

FIG. 5A is a perspective disassembled view of the second slide module;

FIG. 5B is another perspective disassembled view of the second slide module;

FIG. 5C is a schematic view of the second slide module with the second gear in the second limited position;

FIG. 5D is a schematic view of the second slide module with the second gear in the second free position;

FIG. 6A is a schematic view of assembly of the first member and the torque-retaining assembly;

FIG. 6B is another schematic view of assembly of the first member and the torque-retaining assembly;

FIG. 7 is a schematic view of the first sliding track and the second sliding track;

FIG. 8A is a schematic view of the torque-retaining assembly when the second member is between the first position and the central position;

FIG. 8B is a schematic view of the torque-retaining assembly when the second member is between the central position and the second position; and

FIG. 9 is a schematic view of a rack board in a further embodiment.

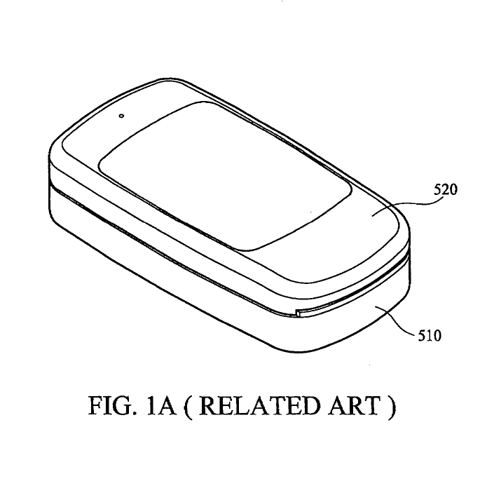

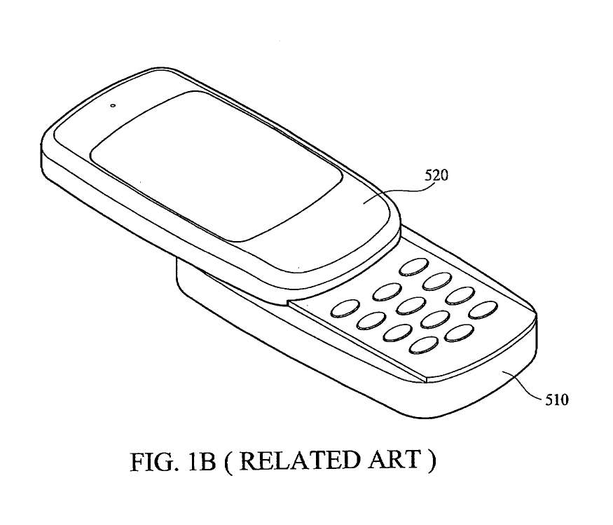

### DETAILED DESCRIPTION

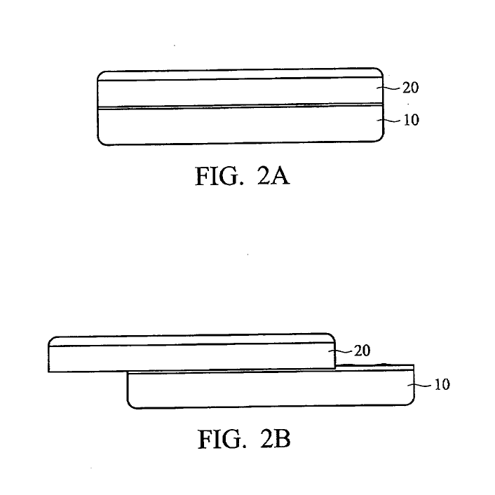

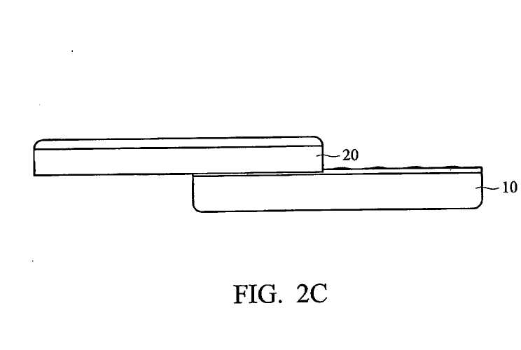

An embodiment of a slide apparatus is hereinafter described with respect to FIG. 2A, FIG. 2B and FIG. 2C. The slide apparatus comprises a first member 10 and a second member 20, both of which are relatively movable. The second member 20 is movable between a first position and a second position in relation to the first member 10, with a central position therebetween. The first position and the second position can alternatively be an open position and a closed position. For example, when the second member 20 in FIG. 2A is in the first position (the closed position), the second member 20 in FIG. 2B is in the central position, and the second member 20 in FIG. 2C is in the second position (the open position).

Further, a torque-retaining assembly is disposed between the first member 10 and the second member 20. When the second member 20 moves from the first position (as shown in FIG. 2A) to the central position (as shown in FIG. 2B), or moves from the second position (as shown in FIG. 2C) to the central position in relation to the first member 10 by an external force, the torque-retaining assembly generates a torque, driving the second member 20 from the central position to the first position or the second position.

In this case, the second member 20 is to be moved from the first position as shown in FIG. 2A to the second position as shown in FIG. 2C, the second member 20 is moved from the first position to the central position as shown in FIG. 2B, and torque generated by the torque-retaining assembly drives the second member 20 from the central position to the second position. Similarly, the second member 20 is to be moved from the second position as shown in FIG. 2C to the first position as shown in FIG. 2A, the second member 20 is moved from the second position to the central position as shown in FIG. 2B, and torque generated by the torque-retaining assembly drives the second member 20 from the central position to the first position. The substantial structure of the torque-retaining assembly is described later.

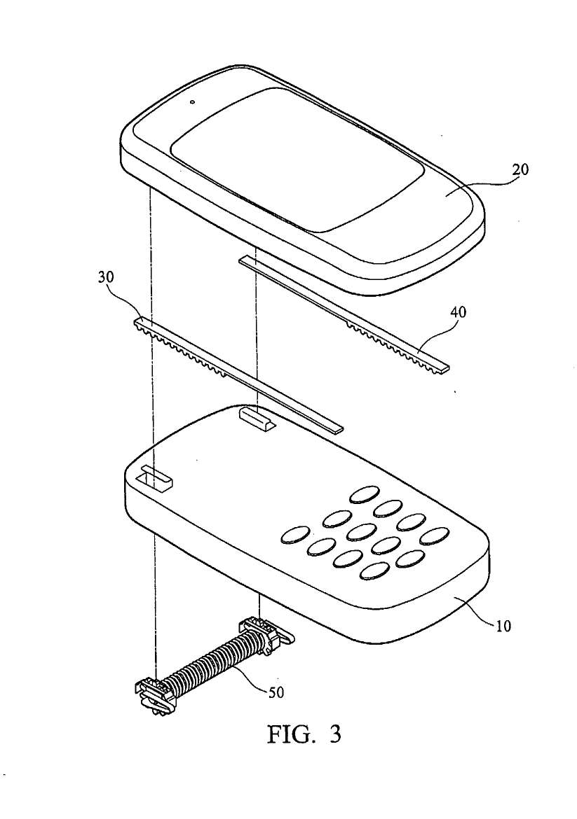

FIG. 3 shows an embodiment of an electronic device. The electronic device applies the slide apparatus, which comprises a first member 10, a second member 20, a first sliding track 30, a second sliding track 40, an elastic element 50, a first slide module and a second slide module. The elastic element 50, the first slide module and the second slide module constitute the torque-retaining assembly.

The first member 10 and the second member 20 can alternatively be a body and a sliding cover of the electronic device. In FIG. 3, for example, the first member 10 is the body and the second member 20 is the sliding cover, but the alternative structure is also applicable. The second member 20 is movable between a first position and a second position in relation to the first member 10, with a central position therebetween, as shown in FIG. 2A to FIG. 2C.

The first slide module and the second slide module are symmetrically disposed on the first member 10. The structures of the two slide modules are hereinafter described in detail.

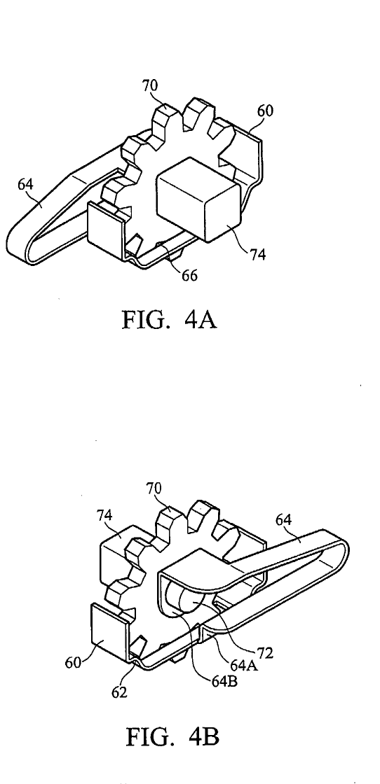

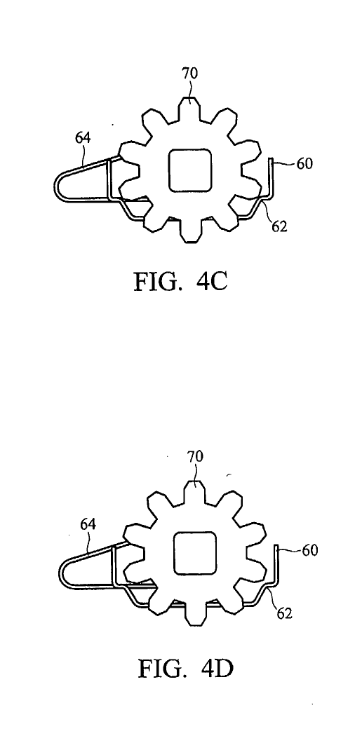

FIG. 4A and FIG. 4B show the elements of the first slide module. The first slide module comprises a first supporting structure 60 and a first gear 70. The first supporting structure 60 is disposed on the first member 10 to support the first gear 70. The first supporting structure 60 comprises a first limiting portion 62 and a first elastic cantilever beam 64. A first fixed end 64A of the first elastic cantilever beam 64 is connected to the first limiting portion 62, and a first free end 64B of the first elastic cantilever beam 64 is connected to a first rotating shaft 72 of the first gear 70. Further, the upper portion of the first supporting structure 60 comprises a first opening 66, exposing a part of the first gear 70.

The first gear 70 is rotatably disposed at the first free end 64B of the first elastic cantilever beam 64 by the first rotating shaft 72. The first rotating shaft 72 protrudes from one side of the first gear 70. On the other side of the first gear 70, a first fixing shaft 74 is provided. Thus, the first gear 70 can move between a first limited position and a first free position by the first elastic cantilever beam 64.

Referring to FIG. 4C, when the first gear 70 is in the first limited position, the first gear 70 is limited by the first limiting portion 62, and is not rotatable in relation to the first supporting structure 60. Referring to FIG. 4D, when the first gear 70 is in the first free position, the first gear 70 is released from the first limiting portion 62, and is rotatable in relation to the first supporting structure 60.

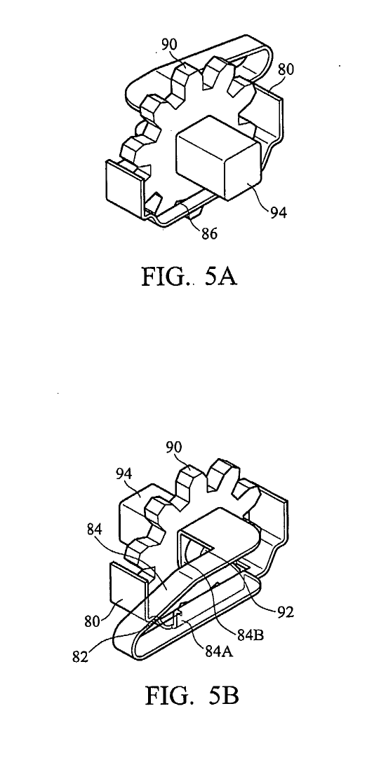

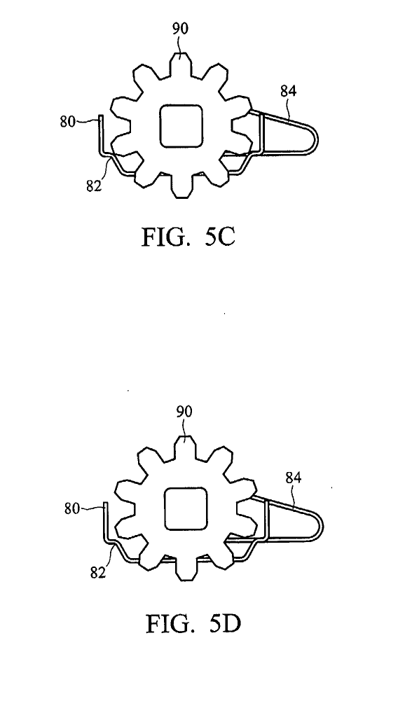

FIG. 5A and FIG. 5B show the elements of the second slide module. The second slide module comprises a second supporting structure 80 and a second gear 90. The second supporting structure 80 is disposed on the first member 10 to support the second gear 90. The second supporting structure 80 comprises a second limiting portion 82 and a second elastic cantilever beam 84. A second fixed end 84A of the second elastic cantilever beam 84 is connected to the second limiting portion 82, and a second free end 84B of the second elastic cantilever beam 84 is connected to a second rotating shaft 92 of the second gear 90. Further, the upper portion of the second supporting structure 80 comprises a second opening 86, exposing a part of the second gear 90.

The second gear 90 is rotatably disposed at the second free end 84B of the second elastic cantilever beam 84 by the second rotating shaft 92. The second rotating shaft 92 protrudes from one side of the second gear 90. On the other side of the second gear 90, a second fixing shaft 94 is provided. Thus, the second gear 90 can move between a second limited position and a second free position by the second elastic cantilever beam 84.

Referring to FIG. 5C, when the second gear 90 is in the second limited position, the second gear 90 is limited by the second limiting portion 82, and is not rotatable in relation to the second supporting structure 80. Referring to FIG. 5D, when the second gear 90 is in the second free position, the second gear 90 is released from the second limiting portion 82, and is rotatable in relation to the second supporting structure 80.

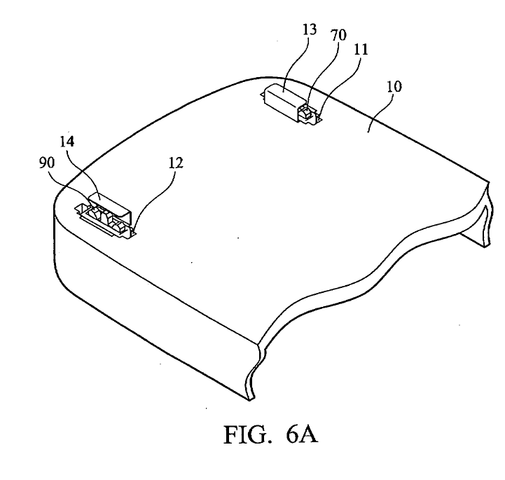

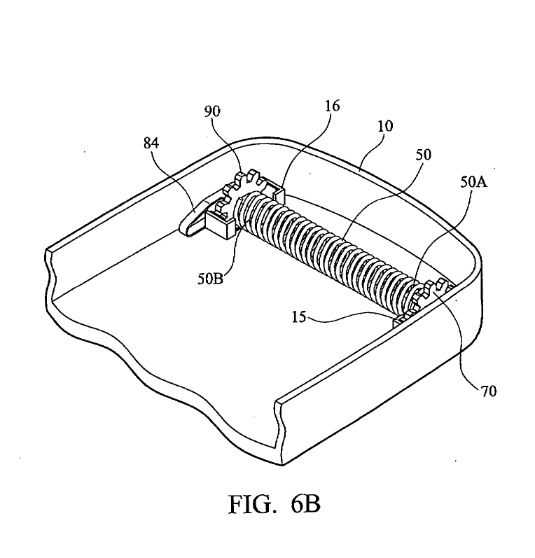

FIG. 6A and FIG. 6B show the assembly of the first member 10, the elastic element 50, the first slide module and the second slide module. As shown in FIG. 6A, the first member 10 comprises a first hole 11, a second hole 12, a first sliding notch 13 and a second sliding notch 14, and the holes and sliding notches are symmetrical. According to FIG. 6B, when the first slide module is disposed on a first connection portion 15 of the first member 10, the first hole 11 enables a part of the first gear 70 to be exposed thereby and corresponds to the first sliding notch 13. Similarly, when the second slide module is disposed on a second connection portion 16 of the first member 10, the second hole 12 enables a part of the second gear 90 to be exposed thereby and corresponds to the second sliding notch 14. The elastic element 50 can be a torsion spring, and comprises a first end 50A and a second end 50B. The first end 50A is fixed to the first fixing shaft 74 of the first gear 70, and the second end 50B is fixed to the second fixing shaft 94 of the second gear 90. The first fixing shaft 74 and the second fixing shaft 94 have non-circular cross sections (in FIG. 4A and FIG. 4B, for example, the first fixing shaft 74 and the second fixing shaft 94 are square columns), and the both ends 50A and 50B of the elastic element 50 are also non-circular, so the elastic element 50 is fixed between the first gear 70 and the second gear 90 without rotation. Thus, the first gear 70 forms a first rotating structure, the second gear 90 forms a second rotating structure, and both rotating structures are respectively rotatable in relation to the elastic element 50 to generate torque.

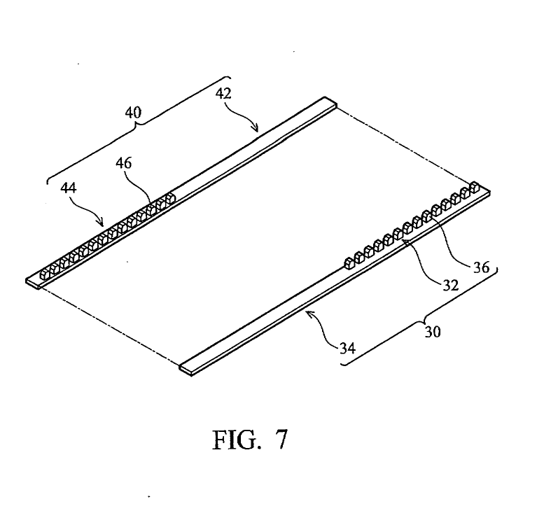

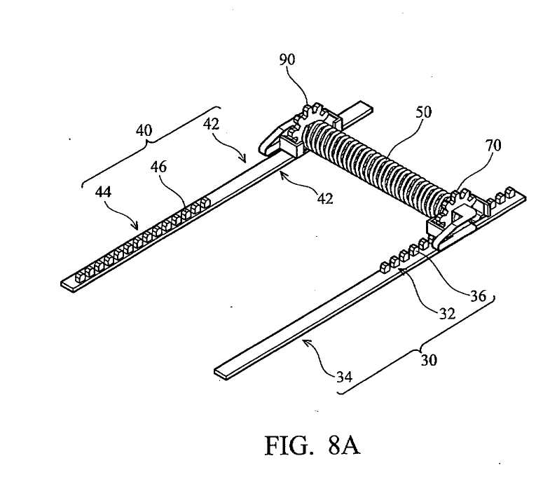

FIG. 7 shows the first sliding track 30 and the second sliding track 40. The first sliding track 30 and the second sliding track 40 are parallel on the second member 20 corresponding to the first sliding notch 13 and the second sliding notch 14. The first sliding track 30 comprises a first track section 32 and a second track section 34, and the second sliding track 40 comprises a third track section 42 and a fourth track section 44. The first track section 32 comprises a first rack 36, and the fourth track section 44 comprises a second rack 46.

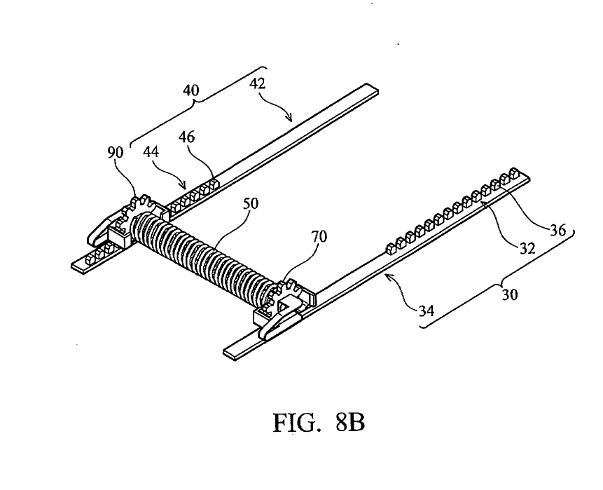

The action of the torque-retaining assembly, formed by the elastic element 50, the first slide module and the second slide module, is described hereinafter in detail with respect to FIG. 8A and FIG. 8B.

In FIG. 8A, when the second member 20 is between the first position (referring to FIG. 2A) and the central position (referring to FIG. 2B) in relation to the first member 10, the first gear 70 corresponds to the first track section 32 of the first sliding track 30, and the second gear 90 corresponds to the third track section 42 of the second sliding track 40. Since the first track section 32 comprises the first rack 36 and the third track section 42 comprises no rack, the first gear 70 engages the first rack 36, moving the first gear 70 to the first free position, and the second gear 90 is in the second limited position. Thus, the first gear 70 (i.e. the first rotating structure) is rotatable, and the second gear 90 (i.e. the second rotating structure) is not.

Further, in FIG. 8B, when the second member 20 is between the central position (referring to FIG. 2B) and the second position (referring to FIG. 2C) in relation to the first member 10, the first gear 70 corresponds to the second track section 34 of the first sliding track 30, and the second gear 90 corresponds to the fourth track section 44 of the second sliding track 40. Since the fourth track section 44 comprises the second rack 46 and the second track section 34 comprises no rack, the second gear 90 engages the second rack 46, moving the second gear 90 to the second free position, and the first gear 70 is in the first limited position. Thus, the first gear 70 (i.e. the first rotating structure) is not rotatable, and the second gear 90 (i.e. the second rotating structure) is rotatable.

In other words, when the second member 20 is to be moved from the first position as shown in FIG. 2A to the second position as shown in FIG. 2C, the second member 20 is moved from the first position to the central position as shown in FIG. 2B. Since the first gear 70 (i.e. the first rotating structure) is rotatable and the second gear 90 (i.e. the second rotating structure) is not when the second member 20 is between the first position and the central position, the elastic element 50 generates torque. When the second member 20 passes the central position, the first gear 70 (i.e. the first rotating structure) is not rotatable, and the second gear 90 (i.e. the second rotating structure) is rotatable. Thus, the torque generated and stored in the elastic element 50 is released, driving the second gear 90 to rotate and moves the second member 20 from the central position to the second position. Thus, no external force is required.

Similarly, when the second member 20 is to be moved from the second position as shown in FIG. 2C to the first position as shown in FIG. 2A, the second member 20 is moved from the second position to the central position as shown in FIG. 2B. Since the first gear 70 (i.e. the first rotating structure) is not rotatable and the second gear 90 (i.e. the second rotating structure) is rotatable when the second member 20 is between the central position and the second position, the elastic element 50 generates torque. When the second member 20 passes the central position, the first gear 70 (i.e. the first rotating structure) is rotatable, and the second gear 90 (i.e. the second rotating structure) is not rotatable. Thus, the torque generated and stored in the elastic element 50 is released, driving the first gear 70 to rotate and moves the second member 20 from the central position to the first position. Thus, no external force is required.

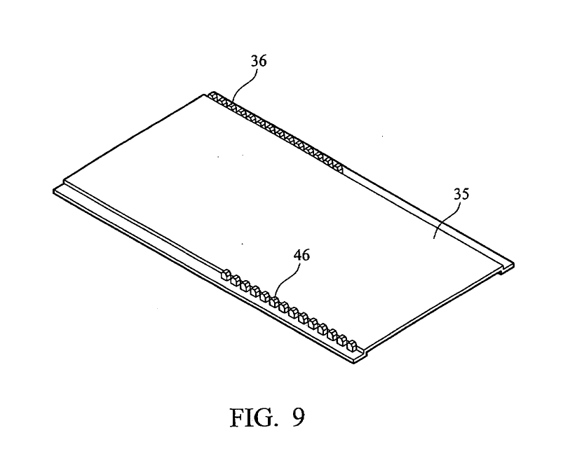

It should be noted that the first sliding track 30 and the second sliding track 40 in FIG. 7 are individual and separate structures. In another embodiment, however, the first sliding track 30 and the second sliding track 40 can be integrally formed as a rack board 35 as shown in FIG. 9.

Further, in the embodiments disclosed, the first position is a closed position, and the second position is an open position. However, the first and second positions can be any positions, not being limited to the embodiments and the figures.

Further, the torsion direction of the elastic element 50 is not limited and can be clockwise or counterclockwise. A variety of torsion spring structures can be employed as the elastic element 50.

While the invention has been described by way of example and in terms of preferred embodiment, it is to be understood that the invention is not limited thereto. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A slide apparatus, comprising:
a first member;
a second member movable between a first position and a second position in relation to the first member, with a central position therebetween; and
a torque-retaining assembly disposed between the first member and the second member;
wherein when the second member moves from the first position to the central position and from the second position to the central position in relation to the first member by an external force, the torque-retaining assembly generates a torque, driving the second member from the central position to the first position or the second position.

2. The slide apparatus as claimed in claim 1, wherein the torque-retaining assembly comprises:
a first slide module disposed on the first member, comprising a first rotating structure rotatable when the second member is between the first position and the central position and not rotatable when the second member is between the central position and the second position;
a second slide module disposed on the first member, comprising a second rotating structure not rotatable when the second member is between the first position and the central position and rotatable when the second member is between the central position and the second position; and
an elastic element comprising a first end fixed to the first rotating structure and a second end fixed to the second rotating structure to generate the torque.

3. The slide device as claimed in claim 2, wherein the first slide module further comprises a first supporting structure supporting the first rotating structure, and the second slide module further comprises a second supporting structure supporting the second rotating structure.

4. The slide apparatus as claimed in claim 2, wherein the first rotating structure is a first gear, and the second rotating structure is a second gear.

5. The slide apparatus as claimed in claim 2, wherein the elastic element is a torsion spring.

6. The slide apparatus as claimed in claim 1, wherein the first member is a body, and the second member is a sliding cover.

7. The slide apparatus as claimed in claim 1, wherein the second member is a body, and the first member is a sliding cover.

8. An electronic device, comprising:
a first member comprising a first sliding notch and a second sliding notch;
a second member movable between a first position and a second position in relation to the first member, with a central position therebetween;
a first slide module disposed on the first member, comprising:
a first supporting structure comprising a first limiting portion and a first elastic cantilever beam; and
a first gear disposed at a first free end of the first elastic cantilever beam and movable between a first limited position and a first free position is by the first elastic cantilever beam, wherein the first gear is not rotatable by limitation of the first limiting portion when the first gear is in the first limited position and rotatable when the first gear is in the first free position;
a first sliding track disposed on the second member corresponding to the first sliding notch, the first sliding track comprising a first track section and a second track section, the first track section comprising a first rack;
a second slide module disposed on the first member, comprising:
a second supporting structure comprising a second limiting portion and a second elastic cantilever beam; and
a second gear disposed at a second free end of the second elastic cantilever beam and movable between a second limited position and a second free position by the second elastic cantilever beam, wherein the second gear is not rotatable by limitation of the second limiting portion when the second gear is in the second limited position and rotatable when the second gear is in the second free position;
a second sliding track parallel to the first sliding track on the second member corresponding to the second sliding notch, the second sliding track comprising a third track section and a fourth track section, the fourth track section comprising a second rack; and
an elastic element comprising a first end fixed to the first gear and a second end fixed to the second gear;
wherein, when the second member is between the first position and the central position in relation to the first member, the first gear corresponds to the first track section and engages with the first rack, moving the first gear to the first free position, and the second gear corresponds to the third track section and is in the second limited position;
when the second member is between the central position and the second position in relation to the first member, the first gear corresponds to the second track section and is in the first limited position, and the second gear corresponds to the fourth track section and engages with the second rack, moving the second gear to the second free position.

9. The electronic device as claimed in claim 8, wherein the first gear comprises a first rotating shaft rotatably connected to the first supporting structure and a first fixing shaft fixing the first end of the elastic element, and the second gear comprises a second rotating shaft rotatably connected to the second supporting structure and a second fixing shaft fixing the second end of the elastic element.

10. The electronic device as claimed in claim 9, wherein the first fixing shaft and the second fixing shaft are square columns.

11. The electronic device as claimed in claim 8, wherein the first member comprises a first connection portion connecting the first slide module and a second connection portion connecting the second slide module.

12. The electronic device as claimed in claim 11, wherein the first supporting structure comprises a first opening, exposing a part of the first gear and the second supporting structure comprises a second opening, exposing a part of the second gear.

13. The electronic device as claimed in claim 12, wherein the first member comprises a first hole corresponding to the first sliding notch, exposing a part of the first gear and a second hole corresponding to the second sliding notch, exposing a part of the second gear.

14. The electronic device as claimed in claim 8, wherein the first member is a body, and the second member is a sliding cover.

15. The electronic device as claimed in claim 8, wherein the second member is a body, and the first member is a sliding cover.

16. The electronic device as claimed in claim 8, wherein the elastic element is a torsion spring.

17. A slide module, comprising:
a supporting structure comprising a limiting portion and an elastic cantilever beam; and
a rotating structure disposed at a free end of the elastic cantilever beam of the supporting structure and movable between a limited position and a free position by the first elastic cantilever beam, wherein the rotating structure is not rotatable by limitation of the limiting portion when the rotating structure is in the limited position and rotatable when the rotating structure is in the free position.

18. The slide module as claimed in claim 17, wherein the rotating structure is a gear.
